(19) United States
(12) Patent Application Publication
(10) Pub. No.: US 2009/0189767 A1
(43) Pub. Date: Jul. 30, 2009

(54) ASSET TRACKING SYSTEM FOR ELECTRONIC EQUIPMENT

(75) Inventors: Michael Primm, Austin, TX (US); Wilfried Gauer, Austin, TX (US); Ron Graczyk, Cedar Park, TX (US); Mitchell Medford, Austin, TX (US)

Correspondence Address: LARSON NEWMAN ABEL & POLANSKY, LLP, 5914 WEST COURTYARD DRIVE, SUITE 200, AUSTIN, TX, 78730, US

(73) Assignee: RF Code, Inc., Austin, TX (US)

(21) Appl. No.: 12/362,351

(22) Filed: Jan. 29, 2009

Related U.S. Application Data
(60) Provisional application No. 61/024,484, filed on Jan. 29, 2008.

(51) Int. Cl. G08B 13/14

(52) U.S. Cl. 340/572.1

(57) ABSTRACT

An asset tracking system includes a server, a plurality of readers in communication with the server, and a plurality of radio frequency identification tags. Each of the plurality of readers is coupled to at least two antennas. The at least two antennas receive signals from a plurality of radio frequency identification tags.

### CORRESPONDING APPLICATIONS

The present application claims priority from U.S. Provisional Patent Application No. 61/024,484, filed Jan. 29, 2008, entitled “ASSET TRACKING SYSTEM FOR ELECTRONIC EQUIPMENT,” naming inventors Michael Primm, and Wilfried Gauer, Ronald Graczyk, which application is incorporated by reference herein in its entirety.

### FIELD OF THE DISCLOSURE

This disclosure, in general, relates to asset tracking systems for electronic equipment and in particular, electronic equipment stored in rack-based arrangements.

### BACKGROUND

Tracking of IT assets in data centers, particularly those containing many enclosed racks of equipment, has been a consistent problem for many years. Traditionally, these assets have been bar-coded for manually scanning, leading to frequent and expensive manual data collection in order to maintain inventory and locate moved assets.

Passive RFID techniques have been attempted and generally involve placing passive RFID tags on the front of the assets. Such techniques involve either installing permanent RFID readers in the racks or manually visiting each rack with a scanner, opening the rack, and sweeping the scanner over the rack to find assets. Installation of permanent readers has proven unreliable and expensive, as placement of tags often results in interference in the ability to read those tags by cables and other obstructions. Manual scanning using hand-held RFID readers has ultimately proven to provide little value over traditional bar-code methods, since it still requires a human visit to each location.

Even with active RFID tags, the problem of locating and isolating tags within a specific rack in a tightly packed data center is significant. The variability of the assets found in a rack presents issues with consistent tag placement. Also, tag mounting often presents problems with cable routing and airflow. Further, the variable nature of the tags themselves, different signal strength from tag to tag due to unit-to-unit inconsistencies, local interference, and other factors serve to worsen the problem of locating specific tagged assets.

As such, an improved tracking system would be desirable.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a data center and rack system.

FIG. 2 includes an illustration of a rail mounting system

FIG. 3, FIG. 4, FIG. 5, FIG. 6, and FIG. 7 include illustrations of exemplary RFID tabs.

FIG. 8, FIG. 9, and FIG. 10 include illustrations of exemplary antenna systems.

FIG. 11 includes an illustration of a confidence value heuristic.

FIG. 12, FIG. 13, and FIG. 14 include illustrations of exemplary asset tracking systems.

FIG. 15 includes an illustration of an exemplary reader.

The use of the same reference symbols in different drawings indicates similar or identical items.

### DESCRIPTION OF THE PREFERRED EMBODIMENT(S)

In a particular embodiment, a system for tracking electronic assets includes a server and a plurality of readers coupled to the server. Each reader is connected to at least one antenna. Generally, the antenna is disposed along a dimension of a rack, such as the vertical dimension, proximal to a side of the rack. For example, the antenna may extend vertically along a front corner of the rack. In another example, a second antenna may be connected to the reader and extend along the dimension of the rack proximal to a second side of the rack. Additionally, readers and connected antennas may be located near portals, such as doors to a facility, one antenna located inside the facility and a second antenna located outside the facility. Further, the system may include a set of radio frequency identification (RFID) tags. An RFID tag may be coupled to an electronic asset located within the rack. In another example, an RFID tag may be part of or in communication with a rack door switch to detect whether a rack door is open.

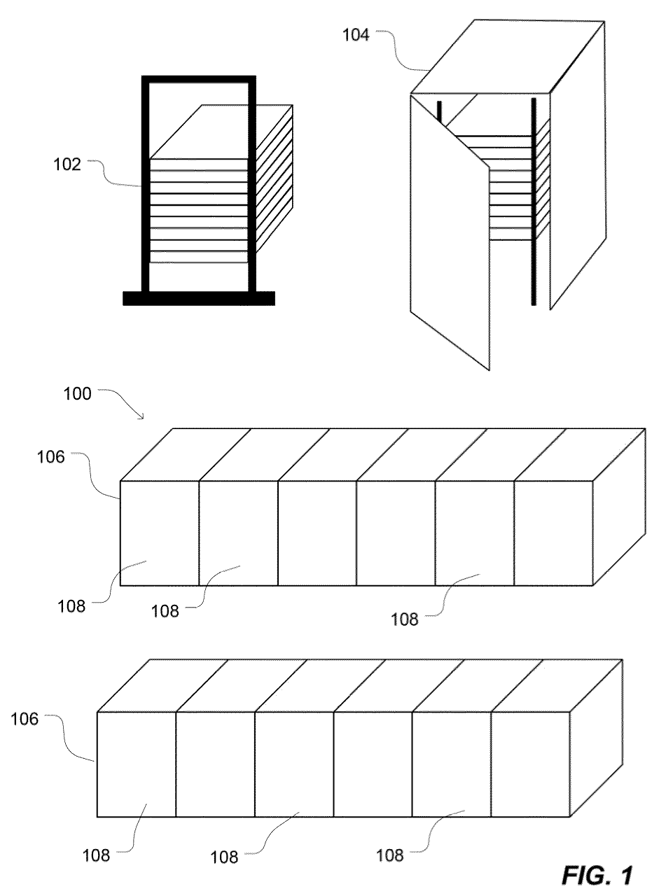

In an example illustrated in FIG. 1, a room, such as a data center 100, includes multiple equipment racks. A typical rack is configured to hold rail-mounted equipment, such as standard 19″ rail mounted equipment. Such racks may be simple, open faced racks 102, possibly consisting of two vertical mounting rails, or may be partially or completely enclosed cabinets 104. Racks are often arranged in rows 106, with little or no spacing between consecutive racks 108. Rows 106 of racks 108 are often arranged side by side, with the fronts of consecutive rows 106 facing one another.

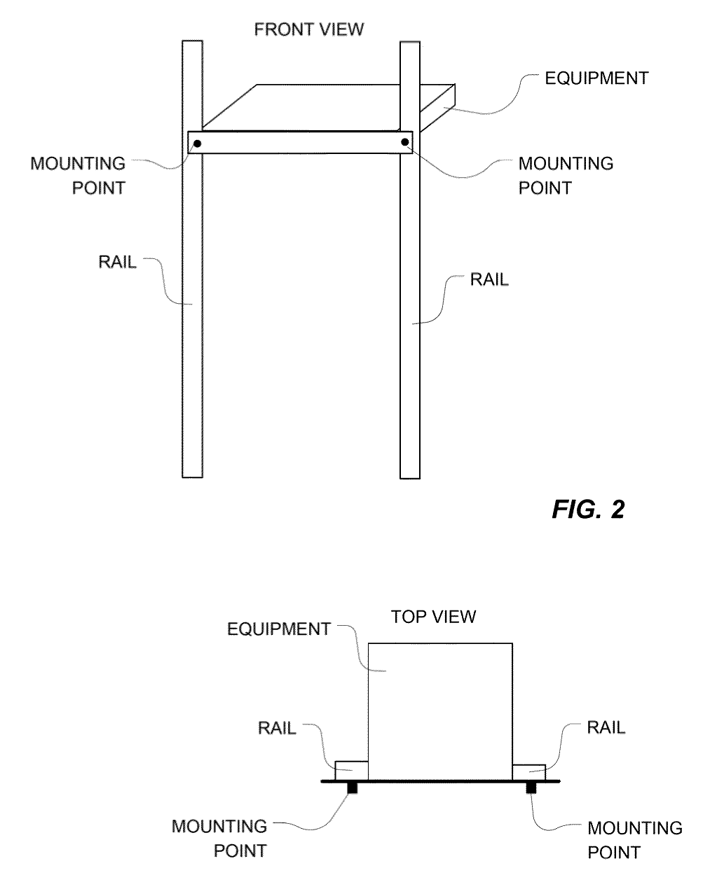

The racks contain electronic and computer equipment, attached on one or both sides to the mounting rails of the rack. For example, a rail mounting system is illustrated in FIG. 2. For nearly all assets, the front face of the asset is nearly flush with the front of the rails used for mounting the asset.

In open-faced racks, the space in front of the equipment is generally available, but often obstructed by routing of IT cabling and the like. In enclosed cabinet racks, the space is further limited by the need to close the door. Typically only a couple of inches are available.

Further, the front face of most equipment is highly utilized, often providing little if any available surface for mounting asset tags or RFID tags, without preventing access to CD/ROM drives, Ethernet ports, or power switches, or obstructing airflow or cable routing.

On devices with available space, a typical mounting of the tags, typically a small rectangular device with an adhesive on the back to secure permanent attachment, can be performed. However, for most assets, typical mounting presents problems, such as limited space or interference with using the space that is available. For example, the front surface of the asset may be covered with connection interfaces, media access, such as CD or DVD access, user interface features, such as indicator lights, vents, or any combination thereof. In addition, the space between assets located within the cabinet may be limited. Moreover, placing an RFID tab between assets may shield the RFID tag and inhibit communication to and from the RFID tag.

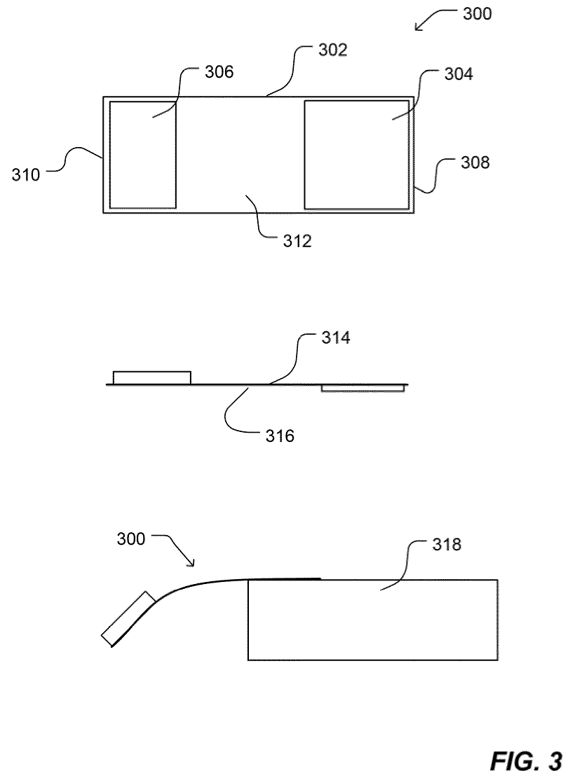

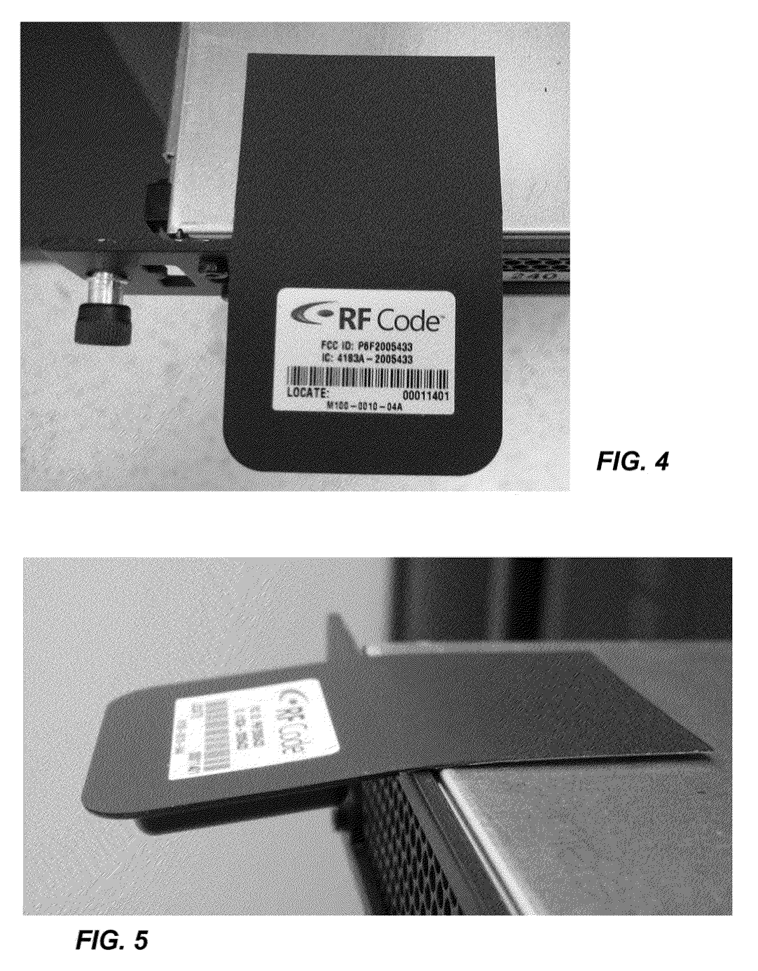

In an exemplary embodiment illustrated in FIG. 3, an RFID tab 300 includes a flexible sheet 302. The sheet 302 may be of various lengths, but is typically 4-5 inches. An RFID circuitry or tag 306 may be mounted on a major surface 314 of the sheet towards one end 310. The RFID tab 300 may also include an adhesive 304 on an opposite end 308 of the sheet 302. For example, the adhesive 304 may be disposed in an area extending at least 0.5 inches, such as at least 0.75 inches, or even approximately 1.0 inches or more from the end 308. The adhesive 304 may be disposed on a second major surface 316 of the sheet 302. Alternatively, the adhesive may be disposed on the same major surface 314 as the tag 306.

In an example, the tag 306 may be molded to the sheet 302. For example, the tag 306 may be vacuum-formed overmolded to the sheet 302. In another example, the tag 306 may be adhered to the sheet 302 using an adhesive layer. In a particular embodiment, a kit may include the sheet 302 having the adhesive 304 covered with a release liner and may include a separate tag 306 with an adhesive backing and release liner. Using the kit, a user may adjust the length of the sheet to a desired length, remove the release liner from the adhesive backing of the tag 306, and adhere the tag 306 to an end of the sheet 302. The adhesive 304 may be placed in contact with an asset to be tracked by removing an associated release liner and pressing the adhesive 304 to the surface of the asset.

In addition, the tab 300 may include an intermediate portion 312 that is free of adhesive and is unobstructed by the tag 306. The intermediate portion 312 may flex, allowing the tag 306 and end 310 of the sheet to move.

In a particular embodiment, the sheet 302 may be formed of a polymeric material, such as a thermoplastic polymer. For example, the thermoplastic polymer may include a polyolefin, a fluoropolymer, a polyamide, a polyester, a polycarbonate, a thermoplastic polyimide, or any combination thereof. The polymeric material may include additives, such as pigments, stabilizers, flame retardant, or any combination thereof. In particular, the polymeric material has a flexural modulus of at least 0.5 GPa, such as at least 0.75 GPa, at least 0.9 GPa, or event at least 1.0 GPa. In general, the flexural modulus is not greater than 5 GPa.

In a particular example, the tab 300 is mounted to an asset 318 to extend from a front surface of the asset 318. As further illustrated in FIG. 4 and FIG. 5, the tab extends out from the plane defined by the front face of the asset.

Further, the tab 300 may include an identification number. For example, the identification number may be located on a surface of the sheet 302. The identification number may be printed on a sticker attached to the sheet 302, as illustrated in FIG. 4 and FIG. 5. In addition, the identification number may be encoded in a bar code. In a particular example, the identification number is located on a surface opposite the surface to which the adhesive 304 is attached for a tab 300 to be adhered to a top surface of an asset and is located on the same surface as the adhesive 304 for a tab 300 to be adhered to a bottom surface of the asset.

In a further example illustrated in FIG. 6, the tab 602 can be shaped as a “T”, with a broader surface at the mounting end 606, allowing for more surface area for a more secure mounting, and a narrower surface at the RFID end 604. In particular, the adhesive 608 may be disposed on the “T” cross portion.

In particular, embodiments of the tag provide technical advantages that overcome unsolved problems, satisfying long felt needs. Generally, prior art tags suffer from poor signal strength and inconvenient attachment configurations that obstruct access to asset components. Passive tags are also sensitive to orientation. Applicants discovered that the source of the signal problem is close proximity of the tag to the surface of the asset, despite front mounting, particularly in close proximity settings, such as closed racks. Applicants discovered that using active tags in the above configuration having a flexible sheet provides enough additional separation to improve signal strength in addition to permitting access to asset components.

As illustrated at FIG. 7, mounting the tag 702 on the flexible plastic tab leads to particular advantages. The top or bottom surface of the equipment 704 for the point of adhesion is consistently available as these positions on rack-mounted equipment are relatively smooth and cannot support airflow. The method of mounting allows the equipment to mount “flush” with other equipment located in the rack position above the equipment. Also, lifting the tag above the ground-plane produced by the equipment generally improves the tag's transmission strength. In addition, the flexible nature of the mount allows the tag to have a degree of freedom that allows access to the features on the equipment (e.g., optical media drawer 706 and cable interface 708), since the tag can be pushed out of the way, while also allowing doors 710 to be closed. Alternatively, the tag may be mounted in a bezel of a server.

To read the tags of the tabs, the system includes a tag reader and associated antennas. Generally, it is desirable to identify a specific rack in which the tag is located. The read range for the tags is not at a premium and the racks are relatively small and closely positioned. In an exemplary embodiment, at least one antenna is located within each rack. The antenna extends along a dimension of the rack, such as a vertical dimension or horizontal dimension. For example, the antenna may extend vertically along one side (left or right) of the front face of the rack.

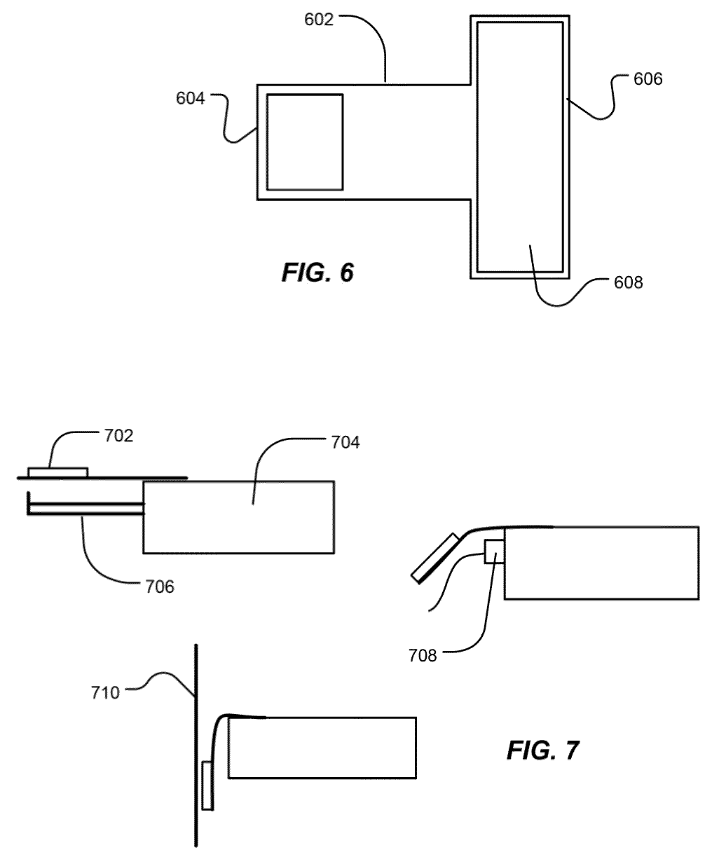

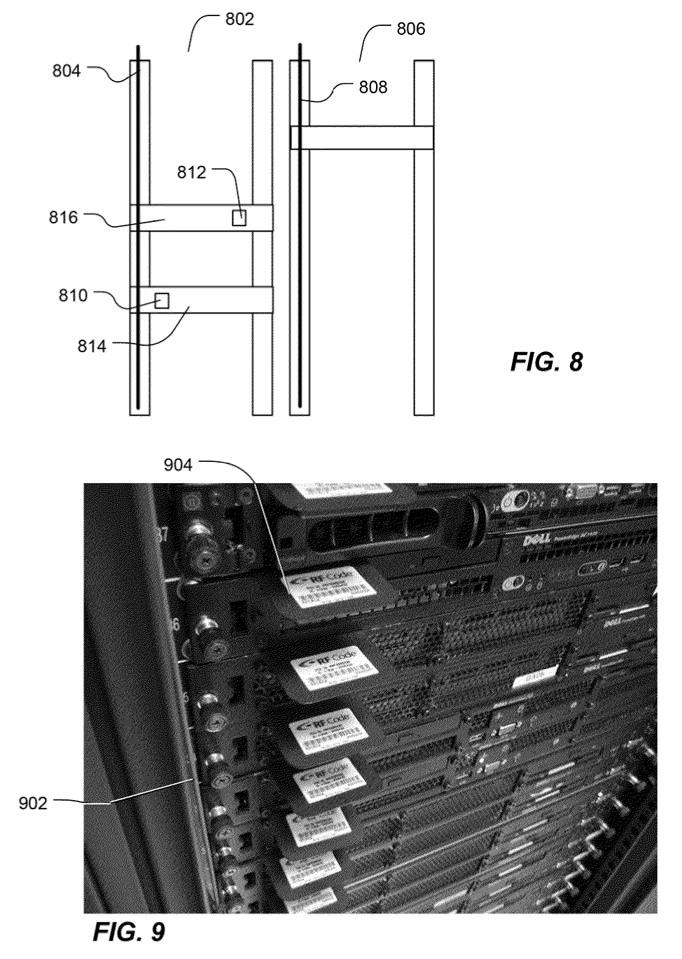

An example is illustrated in FIG. 8. For a rack 802, an antenna 804 extends down a vertical dimension to one side of the front surface of the rack 802. For a rack 806, an antenna 808 extends down a vertical dimension to one side of the front surface of the rack 806. In particular, antennas 804 and 808 extend along the same relative corner of their respective racks 802 and 806. Tags 810 or 812 may be attached to assets 814 or 816, for example, disposed in a rack 802. As illustrated, the tag 810 is located on the asset 814 closer to the antenna 804, and the tag 812 is located on the asset 816 closer to the antenna 808. A reader attached to the antenna may use relative signal strength or a sum of signal strength to determine the location of the tag 810 or 812. Alternatively, more than one antenna may be disposed within each rack. In a further example, each tag may be disposed in the same location relative to a side of the rack.

In a particular embodiment illustrated in FIG. 9, the antenna 902 includes an unshielded cable, mounted from top to bottom in front of the rack's mounting rails. This mounting is preferably placed within the cabinet of an enclosed rack, such that the line-of-sight for the antenna is blocked from directly reaching other racks and tags outside the rack. In particular, the mounting is such that tags 904 placed on assets within the rack have direct line-of-sight with the antenna.

In a further embodiment, to distinguish between tags in a given rack versus in other racks, a tag reader is connected to at least one antenna in the equipment rack itself. With a single antenna, the placement of tags on the front of the equipment is controlled. As illustrated in FIG. 8, with closely spaced racks, the distance between an antenna 804 and a tag 812 in one rack 802 may be more than the distance between the tag 812 in the one rack 802 and an antenna 808 in another rack 806. In an example, a solution includes placing tags on assets in a consistent location, such that the tag is closer to the vertically mounted antenna for a given rack than antennas of other racks. Likewise, antennas may be placed consistently to one side for each rack, such that the distance from tags on assets in the rack is much closer than it would be for tagged assets in other racks. Alternatively, signal strength measurements may be used to determine tag location.

In a further embodiment illustrated in FIG. 10, each rack (1002 or 1004) includes two antennas (1006 and 1008, or 1010 and 1012) connected to a reader (1014 or 1016). Each antenna is associated with an independently processed radio which is capable of measuring, with reasonable accuracy, the signal strength of the tag messages received on that channel. In this case, the tags 1018 or 1020 are found to be between the two channels for a given rack. In particular, the sum of the signal strengths associated with a tag positioned between the two antennas is approximately constant, when measured in dBm. As a tag moves horizontally, its strength will increase on one channel while decreasing on the other. Once the tag moves past one antenna, however, the sum will quickly drop as the strength of both channels will decrease. In a particular embodiment, using a threshold on the sum of the signal strength (SSI), in dBm, produces a heuristic for detecting the presence of the tag in the rack.

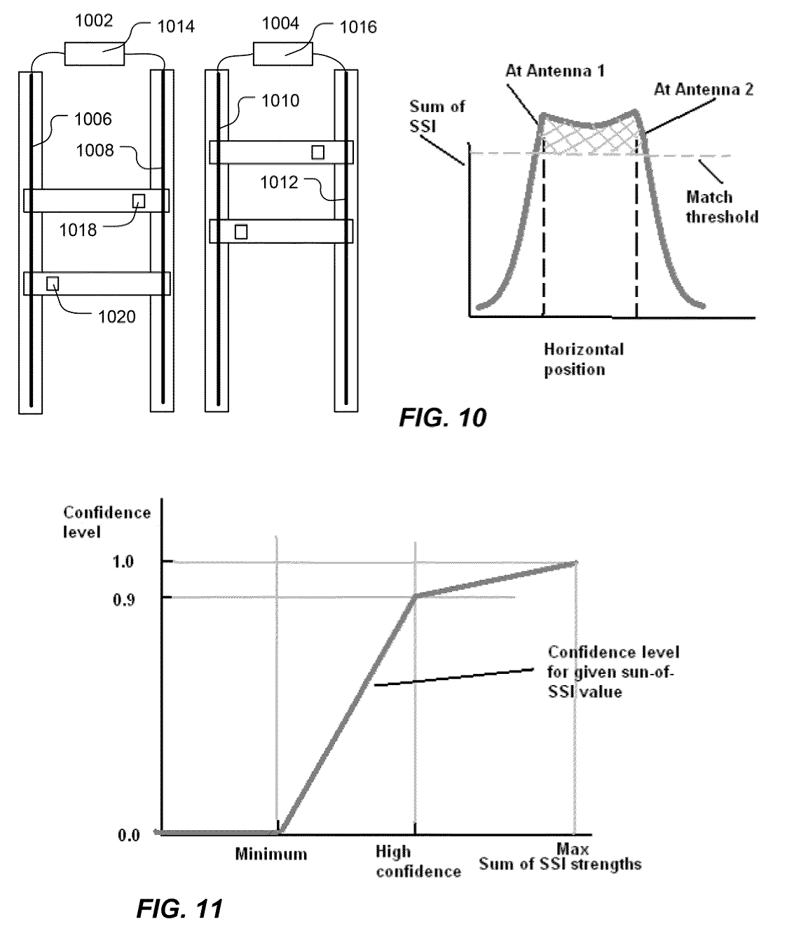

Alternatively, other methods may be used to compensate for tag-to-tag variability. Often, tags can have several dBm of unit-to-unit signal strength difference. As a result, weak tags may not be found to be in the rack that contains them, or strong tags may be found to match more than one rack. In an example, a software system for receiving and comparing the signal strengths from multiple readers in multiple racks can be implemented. In this implementation, the simple yes/no matching heuristic for each rack is instead replaced by a confidence-based heuristic. Using the heuristic input of a particular sum of SSI results in a confidence level or value. In the example embodiment, the heuristic allows the setting of two control levels for the sum of the radio SSI values—one resulting in a minimum (below which the tag is not matching—0.0 confidence), and a second level indicating a “high confidence” match (0.9—maximum confidence is 1.0). In an example illustrated in FIG. 11, the confidence value is determined by assuming a first linear interpolation between 1.0 and 0.9, e.g., if the sum-of-SSI is at or above the “high confidence” level, or the confidence value is determined assuming a second linear interpolation between 0.9 and 0.0, if the sum-of-SSI is between the high confidence and minimum level.

Alternatively, the sum-of-SSI may be correlated to a confidence value or level using a monotonically increasing function. For example, the function may be formulated using a spline, such as a cubic spline. In a particular example, the function may be determined using a cubic B-spline. For example, an SSI value associated with a 0.0 confidence value and an SSI value associated with a 0.9 confidence value may be established by a user or developer. Using the set SSI values, a confidence function may be derived, such as through application of spline or regression techniques. Measurements may then be applied to the confidence function to determine confidence values associated with the location of assets and tags. Alternatively, the monotonically increasing function may be derived by methods involving two or more control points to shape and scale the function.

In a particular example, the confidence levels may be determined for all readers able to observe a given tag, and the resulting confidence vector is used to determine not only which racks are matching, but which one matches best (i.e., has the highest confidence level). By doing so, the lower signal strength of weaker tags is corrected, since all readers will observe the lower signal strength and generate correspondingly lower confidence values.

The two channel method for detecting tags utilizes two antennas coupled to a reader. Periodically, a channel may be misread, a signal may be missed, or an error in reading may occur. Compensation for such errors may be performed by temporarily substituting values for the signal strength of the missed reading. In an exemplary embodiment, the system may discount a configurable number of messages when only one channel is received. In particular, a replacement value of the SSI reading may be determined based at least in part on a prior value of the missing SSI reading. For example, the SSI reading for the missing channel may be assumed (e.g., up to a specific number of cycles or for a specific period) to remain the last reported value. Such an approach prevents occasional transmission errors and collisions from causing the computed location of tags to jump from one location to another (e.g., because the best-matching reader suddenly reported a non-match due to a lost message).

An alternative embodiment includes determining the confidence value as a function of time and one or more prior values of the SSI reading. For example, the function may a slowly decrease from a prior value each time a message from the tag is not received, implying that the tag may have moved out of range quickly. In other example, a moving average of values may be used, such as a simple moving average or an exponential moving average.

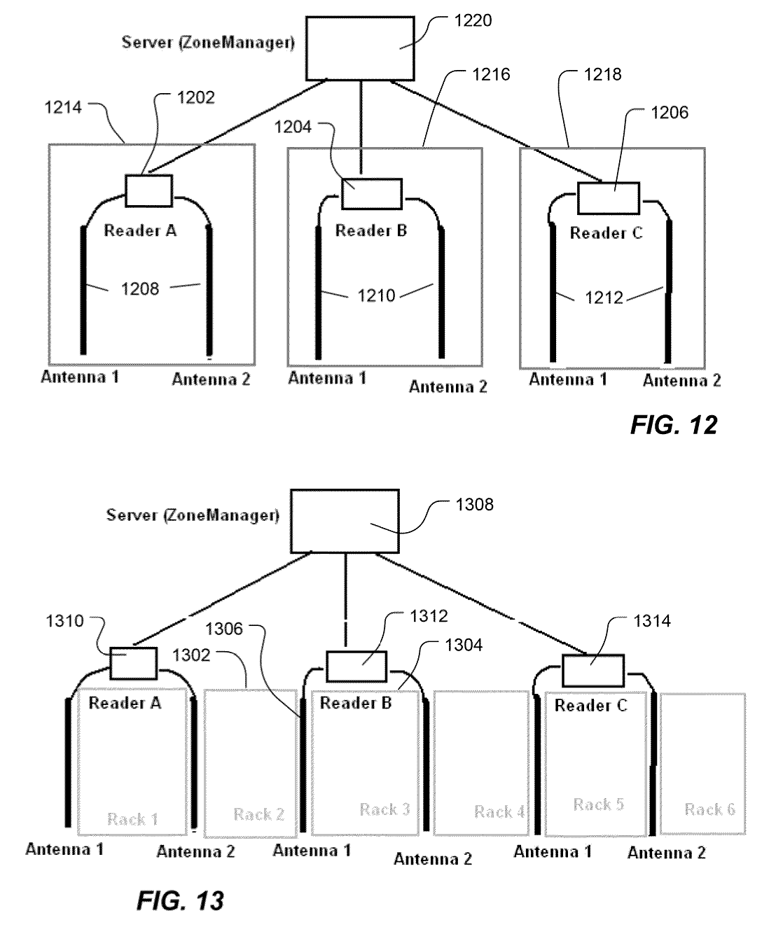

In a particular example illustrated in FIG. 12, the system 1200 may be implemented with a reader (1202, 1204, or 1206) and two antennas (1208, 1210, or 1212) associated with each rack (1214, 1216, or 1218). A plurality of readers (1202, 1204, or 1206) may be coupled to a server 1220. The server 1220 may determine confidence levels and location.

In an alternative example illustrated in FIG. 13, channels are shared between racks. Such an approach may be appropriate for open racks, where the placement of antennas between adjacent racks (e.g., racks 1302 and 1304) results in approximately equivalent observability of tags on both adjacent racks. In this case, the “right” antenna for one rack (e.g., antenna 1306 for rack 1302) is the “left” antenna for the next (e.g., antenna 1306 for rack 1304). By doing so, half as many antennas may be used, and half as many readers. The same matching heuristics can still be used to distinguish between tags in specific racks. A server 1308 is connected to the readers (1310, 1312, or 1314) and may determine the confidence level based on readings from the readers.

Regardless of whether two antennas are associated with a single rack or are disposed between racks, two adjacent antennas may have different length or may be disposed at different offsets from a side or the top of the rack. In particular, two adjacent antennas may be asymmetric in size or absolute position. For example, one of the two adjacent antennas may be at least 5 cm shorter than an adjacent antenna, such as at least 12 cm shorter, at least 25 cm shorter, or at least 50 cm shorter. In another example, one antenna may be disposed at least 1 cm further from a side of the rack opposite the side of the rack adjacent to the second antenna relative to the second antenna. For example, the one antenna may be disposed at least 2 cm further than the second antenna. In an additional example, the one antenna may be disposed at least 2 cm further from the top of the rack than the second antenna, such as at least 5 cm, at least 10 cm, or even at least 20 cm. In particular, the asymmetric disposition or difference in length improves detection of tags and reduces detection error.

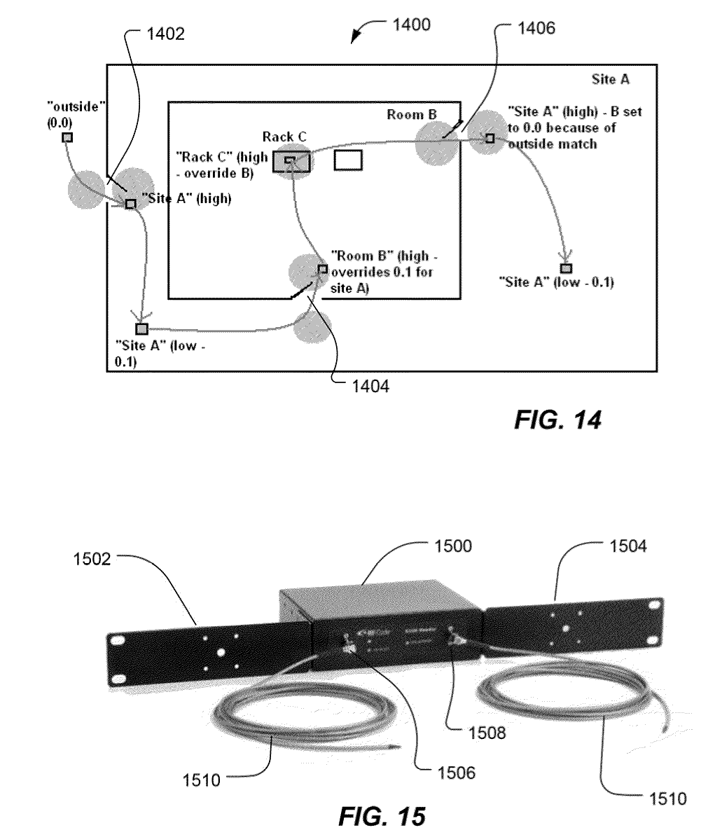

In a particular embodiment, the reader is rack mounted. For example, as illustrated in FIG. 15, the reader 1500 may include braces 1502 or 1504 for mounting on a rack. In addition, the reader 1500 may include front-side access 1506 and 1508 for attaching antennas. Further, the reader 1500 may be supplied with antennas 1510, an antenna guide or mount (not shown), or antenna protectors. The antenna guide or mount may be used to guide the antenna along a dimension of the rack. The antenna protector may be placed over the antenna when the antenna is in close proximity to metal surfaces to prevent contact with the metal surface. Alternatively, the reader 1500 may be mounted on top of a rack or under a rack. The antennas may extend into the rack via holes in the rack housing.

In a further embodiment, a reader may be configured to read both stationary tags coupled to fixed assets (e.g., server equipment) and mobile tags associated with moving assets (e.g., personnel tags). Such a system may be used, for example, to track which employee visits which rack.

When communicated across a shared network, such as TCP/IP over Ethernet, reports of messages from a given tag may not arrive at the same time at the software server doing the comparison. In a particular example, the software comparing the results from different readers in different racks compensates for the delayed communication. In an exemplary embodiment, the reception of a message from a given tag triggers a delayed processing request to be queued for handling after a specific time period, such as 1 second, allowing time for the other readers to report updates associated with the same tag before the confidence functions are recomputed for all the reporting readers. The time period may be a default value programmed into the system or the time period may be a parameter that is adjustable by a user. Such an approach prevents problems with a tag when recently moved—one reader may report the tag event first, but it may not be the reader ultimately reporting the highest confidence values. By delaying a period of time corresponding to the worst-case transmission delay for a reader reporting to the server application, it can be assumed that readers that received the transmission from the tag have reported their observations of that transmission consistently.

The use of the confidence functions and comparison of confidence values, allows the rack-detection solution to be combined with other location heuristics. In a particular embodiment, RFID tags can include infrared sensors that can be used to observe location codes transmitted by special IR beacons. These IR beacons are placed in specific locations, and are considered reliable location indicators. In an example, tags reporting a recognized IR beacon code are considered “maximum confidence” (1.0), resulting in the IR beacon confidence values overriding those from the rack heuristics.

Another heuristic used in association with the rack detection solution is an entry-exit threshold based heuristic. In this heuristic, a location 1400 (room, facility, site) has one or more entry portals (1402, 1404, or 1406), as illustrated in FIG. 14. At each portal, one or more antennas are placed in such a way that they detect RFID tags that are on the outside of the portal. Likewise, one or more antennas are placed in such a way that they detect RFID tags that are on the inside of the portal (e.g., the side representing the location of interest, such as in a room or in a building). In this case, tags can be reported as potentially matching the location by measuring the strongest signal strength reported by the antennas and seeing if it is from an inside or an outside antenna. If the strongest is inside, the relative strength is used to generate a non-zero confidence level. If the strongest is outside, the tag does not match the location (confidence is 0.0). If neither matches (the tag is unseen, or below minimum for all antennas), the heuristic may assume (with a low confidence) that the last result still applies (e.g., if it was outside, it is still outside (confidence 0.0); if it was inside the location, it is still inside, but with low confidence).

Further, the system may track a history of the changes noting whether the signal strength was first higher outside followed by a high inside or was first high inside followed by a high outside. Matching with a low confidence once the tag is inside the site allows large sites to be handled without requiring comprehensive reader coverage, the assumption being that the tag is seen when passing through the entry-exit portals. Further, if additional readers and heuristics are configured within the site, the low confidence level allows those heuristics to match, since they are likely more specific locations (e.g., a specific rack versus the whole data center). By maintaining the low-confidence match until the tag is seen to leave, the site-level location again matches when the tag no longer matches the more specific heuristics (i.e., leaves the rack that it was in). In an embodiment, the specific value used for the low-confidence is settable, allowing nesting of entry-exit thresholds. For example, a site may report 0.01 as its low confidence match, while a specific building reports 0.02, and a specific data center in the building 0.03.

In particular, active RFID tags offer an advantage in this scenario on several fronts. First, by being self-powered and producing a stronger transmission signal than is available to passive RFID tags, the ability to track tags within a rack is improved. Active RFID tags also offer continuous monitoring, allowing real-time inventory as well as the option of additional telemetry (e.g., temperature, tamper detection, etc). In particular, the tags may be capable of transmitting their presence and ID, in addition to other date. For example, a temperature sensor or airflow sensor could be embedded to show the input or exhaust qualities for a particular device being monitored. In another example, infra red sensors can also be added to add to the positioning inside or outside the rack. In a further example, the additional telemetry may be to detect whether a rack door is open or closed.

In a first embodiment, a method of asset tracking includes receiving a first signal from a radio frequency identification tag via a first antenna, receiving the second signal from the radio frequency identification tag via a second antenna, and determining a location of the radio frequency identification tag based at least in part on the sum of the first and second strengths. The first antenna extends along a dimension of an equipment rack. The first signal has a first strength. The second antenna extends parallel to the first antenna along the dimension of the equipment rack. The second signal has a second strength. In an example, the first antenna is oriented along a first side of the equipment rack. In another example, the second antenna is oriented along a second side of the equipment rack.

In a first example of the first embodiment, determining the location includes applying a heuristic to the sum of the first and second strengths to determine a confidence level. In a second example, determining the location includes applying the sum of the first and second strengths to a monotonic function to determine a confidence level. In a further example, applying the sum of the first and second strengths to a monotonic function includes applying the sum of the first and second strengths to a cubic function.

In another example of the first embodiment, the method further comprises delaying determination of the location by a fixed period starting when receiving the signal at the first antenna. In an additional example of the first embodiment, the method further comprises redetermining the location at a subsequent time based on a subsequently received first strength and using a value equal to the second strength when a subsequent second strength is not received. In a further example of the first embodiment, the method further comprises redetermining the location at a subsequent time based on a subsequently received first strength and using a value based at least in part on the second strength when a subsequent second strength is not received. For example, the value includes a moving average.

In a second embodiment, an identification tag includes a flexible sheet having a first major surface and a second major surface, an adhesive layer disposed on the first major surface of the flexible sheet proximal to a first end of the flexible sheet, and an active radio frequency identification circuitry coupled to the flexible sheet at a second end of the flexible sheet.

In an example of the second embodiment, the identification tag further comprises an identification number located proximal to the second end of the flexible sheet. For example, the identification number may be encoded in a bar code. In another example, the identification number is disposed on the first major surface of the flexible sheet. In an additional example, the identification number is disposed on the second major surface of the flexible sheet.

In a further example of the second embodiment, the active radio frequency identification circuitry is coupled to the first major surface of the flexible sheet. In another example, the active radio frequency identification circuitry is coupled to the second major surface of the flexible sheet. In an additional example, the flexible sheet further comprises an intermediate portion between the first end and the second end, the intermediate portion being free of adhesive and unobstructed by the active radio frequency identification circuitry.

In another example of the second embodiment, the flexible sheet forms a “T” shape at the first end.

In a third embodiment, an asset tracking system includes a reader, at least one antenna coupled to the reader and disposed along a dimension of an equipment rack, and a radio frequency identification tag. The radio frequency identification tag includes a flexible sheet having a first major surface and a second major surface, an adhesive layer disposed on the first major surface of the flexible sheet proximal to a first end of the flexible sheet, and an active radio frequency identification circuitry coupled to the flexible sheet at a second end of the flexible sheet. The reader is to determine the location of the RFID tag relative to the equipment rack.

In a fourth embodiment, an asset tracking system includes a reader, a first antenna coupled to the reader and disposed along a dimension of an equipment rack proximal to a first side, a second antenna coupled to the reader and disposed along the dimension of the equipment rack proximal to a second side, and a radio frequency identification tag. The first antenna is to receive a first signal from the radio frequency identification tag via a first channel. The second antenna is to receive a second signal from the radio frequency identification tag via a second channel. The system is to determine the location of the radio frequency identification tag based at least in part on the strength of the first and second signals.

In an example of the fourth embodiment, the location of the radio frequency identification tag is determined based at least in part on the sum of the signal strength of the first and second signals received at the first and second antennas, respectively. In another example, a confidence level is determined based at least in part on the strength of the signal received at the first and second antennas.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A method of asset tracking, the method comprising:
receiving a first signal from a radio frequency identification tag via a first antenna, the first antenna extending along a dimension of an equipment rack, the first signal having a first strength;
receiving the second signal from the radio frequency identification tag via a second antenna, the second antenna extending parallel to the first antenna along the dimension of the equipment rack, the second signal having a second strength;
determining a location of the radio frequency identification tag based at least in part on the sum of the first and second strengths.

2. The method of claim 1, wherein the first antenna is oriented along a first side of the equipment rack.

3. The method of claim 1, wherein the second antenna is oriented along a second side of the equipment rack.

4. The method of claim 1, wherein the first antenna is shorter than the second antenna.

5. The method of claim 1, wherein the first antenna is asymmetrically disposed relative to the second antenna.

6. The method of claim 1, wherein determining the location includes applying a heuristic to the sum of the first and second strengths to determine a confidence level.

7. The method of claim 1, wherein determining the location includes applying the sum of the first and second strengths to a monotonic function to determine a confidence level.

8. The method of claim 7, wherein applying the sum of the first and second strengths to a monotonic function includes applying the sum of the first and second strengths to a cubic function.

9. The method of claim 1, further comprising delaying determination of the location by a fixed period starting when receiving the signal at the first antenna.

10. The method of claim 1, further comprising redetermining the location at a subsequent time based on a subsequently received first strength and using a value equal to the second strength when a subsequent second strength is not received.

11. The method of claim 1, further comprising redetermining the location at a subsequent time based on a subsequently received first strength and using a value based at least in part on the second strength when a subsequent second strength is not received.

12. The method of claim 11, wherein the value includes a moving average.

13. An identification tag comprising:
a flexible sheet having a first major surface and a second major surface;
an adhesive layer disposed on the first major surface of the flexible sheet proximal to a first end of the flexible sheet; and
an active radio frequency identification circuitry coupled to the flexible sheet at a second end of the flexible sheet.

14. The identification tag of claim 13, further comprising an identification number located proximal to the second end of the flexible sheet.

15. The identification tag of claim 14, wherein the identification number is encoded in a bar code.

16. The identification tag of claim 14, wherein the identification number is disposed on the first major surface of the flexible sheet.

17. The identification tag of claim 14, wherein the identification number is disposed on the second major surface of the flexible sheet.

18. The identification tag of claim 13, wherein the active radio frequency identification circuitry is coupled to the first major surface of the flexible sheet.

19. The identification tag of claim 13, wherein the active radio frequency identification circuitry is coupled to the second major surface of the flexible sheet.

20. The identification tag of claim 13, wherein the flexible sheet further comprises an intermediate portion between the first end and the second end, the intermediate portion being free of adhesive and unobstructed by the active radio frequency identification circuitry.

21. The identification tag of claim 13, wherein the flexible sheet forms a “T” shape at the first end.

22. An asset tracking system comprising:
a reader;
at least one antenna coupled to the reader and disposed along a dimension of an equipment rack; and
a radio frequency identification tag comprising:
a flexible sheet having a first major surface and a second major surface;
an adhesive layer disposed on the first major surface of the flexible sheet proximal to a first end of the flexible sheet; and
an active radio frequency identification circuitry coupled to the flexible sheet at a second end of the flexible sheet;
wherein the reader is to determine the location of the RFID tag relative to the equipment rack.

23. An asset tracking system comprising:
a reader;
a first antenna coupled to the reader and disposed along a dimension of an equipment rack proximal to a first side;
a second antenna coupled to the reader and disposed along the dimension of the equipment rack proximal to a second side; and
a radio frequency identification tag;
wherein the first antenna is to receive a first signal from the radio frequency identification tag via a first channel, the second antenna is to receive a second signal from the radio frequency identification tag via a second channel, the system to determine the location of the radio frequency identification tag based at least in part on the strength of the first and second signals.

24. The asset tracking system of claim 23, wherein the location of the radio frequency identification tag is determined based at least in part on the sum of the signal strength of the first and second signals received at the first and second antennas, respectively.

25. The asset tracking system of claim 23, wherein a confidence level is determined based at least in part on the strength of the signal received at the first and second antennas.

26. The asset tracking system of claim 23, wherein the first antenna is shorter than the second antenna.

27. The asset tracking system of claim 23, wherein the first antenna is asymmetrically disposed relative to the second antenna.
